(19) United States
(12) Patent Application Publication
(10) Pub. No.: US 2013/0142908 A1
(43) Pub. Date: Jun. 6, 2013

(54) METHOD FOR IMPROVING THE SURVIVAL RATE OF PROBIOTIC

(71) Applicant: Anders Henriksson, Zetland (AU)

(72) Inventor: Anders Henriksson, Zetland (AU)

(73) Assignee: DUPONT NUTRITION BIOSCIENCES APS, DK-1001 COPENHAGEN K, DK (DK)

(21) Appl. No.: 13/817,280

(22) PCT Filed: Aug. 16, 2011
(86) PCT No.: PCT/EP2011/064106

§ 371 Date: Feb. 15, 2013

Related U.S. Application Data
(60) Provisional application No. 61/374,067, filed on Aug. 16, 2010.

(30) Foreign Application Priority Data
Aug. 16, 2010 (EP) 10172932.5

(51) Int. Cl. A23L 1/30; A23K 1/00

(52) U.S. Cl. CPC A23L 1/3014; A23K 1/009
USPC 426/61; 435/252.9; 435/252.1

(57) ABSTRACT

The present invention relates to the improvement of the survival rate of probiotic strains such as Lactobacillus acidophilus or Bifidobacterium ssp. by Lactobacillus strains that enhance the survival rate of probiotic strains in food or feed products.

### FIELD OF THE INVENTION

The present invention relates to the improvement of the survival rate of probiotic strains such as Lactobacillus acidophilus or Bifidobacterium ssp. by Lactobacillus strains that enhance the survival rate of probiotic strains in food or feed products.

### BACKGROUND OF THE INVENTION

Lactobacillus acidophilus and Bifidobacterium ssp. are the most commonly used probiotics. Their presence in the gastrointestinal tract aids in maintaining a desirable gastrointestinal microbiota, helps in preventing infection by pathogenic bacteria and is in other ways of benefit to the host.

Live probiotic cultures, and especially L. acidophilus or Bifidobacterium ssp, are available in fermented dairy products, such as yogurt. However, during storage of the fermented dairy product, the survival rate of L. acidophilus or Bifidobacterium ssp in said product decreases. As a consequence, the content of live L. acidophilus in yogurt at the time of the ingestion of the finished product, by the consumer, may not be sufficient enough to have a desirable impact on the host gastrointestinal tract. This is even more critical in areas wherein storage at cold, dry and constant temperature is difficult.

EP 2194118 describes the use of Propionibacterium freudenreichii to improve survival of lactic acid bacterium in yogurts. WO 2010/023290 describes the use of Lactococcus lactis and Streptococcus thermophilus for improving the growth of Bifidobacterium strain in fermented dairy products. WO 2008/148561 describes the use of a specific Streptococcus thermophilus for improving the growth of Bifidobacterium strain in fermented dairy products. But none of these documents put in evidence that Lactobacillus strains can enhance the survival of probiotic strains.

### SUMMARY OF THE INVENTION

The problem to be solved is to improve the survival rate of probiotic strains in food or feed products.

The solution is based on the finding of the present inventors that Lactobacillus strains, and in particular Lactobacillus paracasei or Lactobacillus rhamnosus strains increase the survival rate (or viability) of probiotic strains and in particular Lactobacillus acidophilus and Bifidobacterium ssp during the storage of food or feed products.

In a first aspect, the present invention is drawn to a method for preparing a food or feed product comprising:

inoculating a medium with a probiotic strain, and a Lactobacillus strain that enhances the survival rate of the probiotic strain.

In one specific embodiment, the Lactobacillus strain that enhances the viability of the probiotic strain is a Lactobacillus paracasei strain or a Lactobacillus rhamnosus strain and the probiotic strain is a Lactobacillus acidophilus strain or a Bifidobacterium ssp. strain.

In another aspect, the present invention is directed to the use of a Lactobacillus strain in the manufacture of a food or feed product containing a probiotic strain for increasing the survival rate of said probiotic strain during the storage of said food or feed product.

### DETAILED DESCRIPTION

The present invention is directed to a method for preparing a food or feed product comprising:

inoculating a medium with a probiotic strain, and a Lactobacillus strain that enhances the survival rate of the probiotic strain.

In the present invention, the term probiotic refers to microorganisms that may have a beneficial effect on human health or refers in particular to lactic acid bacteria selected from the group consisting of the genera Lactococcus (such as Lactococcus cremoris and Lactococcus lactis), Lactobacillus (such as Lactobacillus acidophilus, Lactobacillus casei, Lactobacillus kefiri, Lactobacillus bifidus, Lactobacillus brevis, Lactobacillus helveticus, Lactobacillus paracasei, Lactobacillus rhamnosus, Lactobacillus salivarius, Lactobacillus curvatus, Lactobacillus bulgaricus, Lactobacillus sakei, Lactobacillus reuteri, Lactobacillus fermentum, Lactobacillus farciminis, Lactobacillus lactis, Lactobacillus delbrueckii, Lactobacillus plantarum, Lactobacillus paraplantarum, Lactobacillus crispatus, Lactobacillus gasseri, Lactobacillus johnsonii and Lactobacillus jensenii), Leuconostoc, Carnobacterium, Enterococcus, Propionibacteium, Pediococcus, Streptococcus and Bifidobacterium (such as Bifidobacterium lactis, Bifidobacterium bifidium, Bifidobacterium longum, Bifidobacterium animalis, Bifidobacterium breve, Bifidobacterium infantis, Bifidobacterium catenulatum, Bifidobacterium pseudocatenulatum, Bifidobacterium adolescentis, and Bifidobacterium angulatum).

The probiotic strain is advantageously inoculated into the milk in an amount of 10⁸ to 10¹¹ cfu/L, preferably from 10⁹ to 10¹¹ cfu/L.

The Lactobacillus strain that enhances the survival rate of the probiotic strain is advantageously inoculated into the milk in an amount of 10⁸ to 10¹¹ cfu/L, preferably from 10⁹ to 10¹° cfu/L.

The ratio between the Lactobacillus strain that enhances the survival rate of the probiotic strain and the probiotic strain in the milk is advantageously from 1:10 to 50:1, preferably from 1:1 to 20:1, more preferably from 5:1 to 15:1.

The Lactobacillus strain that enhances the survival rate of the probiotic strain is of course different from the probiotic strain. Said Lactobacillus strain is for example selected from the group consisting of a Lactobacillus paracasei strain, a Lactobacillus casei strain or a Lactobacillus rhamnosus strain.

The probiotics are for example selected from the group consisting of Lactobacillus helveticus, Lactobacillus crispatus, Lactobacillus jensonii, Lactobacillus gasseri, Lactobacillus acidophilus and Bifidobacterium ssp.

Advantageously, the Lactobacillus strain that enhances the viability of the probiotic strain is a Lactobacillus paracasei strain or a Lactobacillus rhamnosus strain and the probiotic strain is a Lactobacillus acidophilus strain or a Bifidobacterium ssp. strain.

Advantageously, the Lactobacillus paracasei strain is selected from the group consisting of the strains Lb2132, lbc-82, LC-10 and Lpc-37. The lbc-82 strain is available from Danisco commercial products LBC 82 Lyo or CHOOZIT ARO LYO. The LC-10 strain is available from Danisco commercial products FLAVO BAC LF 302 and LbC81a. The LB2132 strain is available from Danisco commercial product Holdbac™ YMC. The strains available from commercial mixtures can be easily isolated with methods well know to the skilled person such as MRS agar supplemented with vancomycin, as described by Su et al (Lett Appl Microbiol 2006, 44:120-125). The Lpc-37 strain is commercially available from Danisco A/S and has been described in the patent document WO 04052462 under the ATCC deposit number PTA-4798.

Advantageously, the Lactobacillus rhamnosus strain is selected from the group consisting of the strains Lr-32 and HN001, which are commercially available from Danisco A/S. Lr-32 has been described in the patent document EP 2245943 under the DSMZ deposit number DSM 22193. Strain HN001, which is also known as HOWARU™ Rhamnosus is commercially available from Danisco A/S.

Advantageously, the Lactobacillus acidophilus strain is selected from the group of La-14 and NCFM, which are commercially available from Danisco A/S. NCFM has been described in the patent document WO 04052462 under the ATCC deposit number PTA-4797.

The Bifidobacterium ssp. strain is advantageously selected from the group consisting of Bifidobacterium lactis, Bifidobacterium bifidium, Bifidobacterium longum, Bifidobacterium animalis, Bifidobacterium breve, Bifidobacterium infantis, Bifidobacterium catenulatum, Bifidobacterium pseudocatenulatum, Bifidobacterium adolescentis, and Bifidobacterium angulatum. Preferably, the bifidobacterium ssp. strain is a strain of Bifidobacterium animalis lactis, in particular strains HN019 or Bl-04, which are commercially available from Danisco A/S.

In a particular aspect of the invention, the food or feed product obtained by the process of the present invention does not contain a Propionibacterium freudenreichii strain.

In a particular embodiment, the present invention is directed to a method for preparing a food or feed product comprising:

inoculating a medium with a Lactobacillus acidophilus strain, and a Lactobacillus strain selected from a Lactobacillus paracasei strain or a Lactobacillus rhamnosus strain.

Advantageously, the Lactobacillus paracasei strain is selected from the group consisting of the strains Lb2132, lbc-82, LC-10 and Lpc-37.

Advantageously, the Lactobacillus rhamnosus strain is selected from the group consisting of the strains Lr-32 and HN001.

Advantageously, the Lactobacillus acidophilus strain is selected from the group of La-14 and NCFM.

The Lactobacillus paracasei strain or the Lactobacillus rhamnosus strain is inoculated into the milk in an amount of 10⁸ to 10¹¹ cfu/L, preferably from 10⁹ to 10¹° cfu/L.

The Lactobacillus acidophilus strain is inoculated into the milk in an amount of 10⁸ to 10¹¹ cfu/L, preferably from 10⁹ to 10¹¹.

The ratio between the Lactobacillus paracasei strain or the Lactobacillus rhamnosus strain and the Lactobacillus acidophilus strain inoculated into the milk is advantageously from 1:10 to 50:1, preferably from 1:1 to 20:1, more preferably from 5:1 to 15:1.

In another particular embodiment, the present invention is directed to a method for preparing a food or feed product comprising:

inoculating a medium with a Bifidobacterium strain, and a Lactobacillus strain selected from Lactobacillus paracasei or Lactobacillus rhamnosus.

The Bifidobacterium strain is advantageously selected from the group consisting of Bifidobacterium lactis, Bifidobacterium bifidium, Bifidobacterium longum, Bifidobacterium animalis, Bifidobacterium breve, Bifidobacterium infantis, Bifidobacterium catenulatum, Bifidobacterium pseudocatenulatum, Bifidobacterium adolescentis, and Bifidobacterium angulatum.

Advantageously, the bifidobacterium is a strain of Bifidobacterium animalis lactis, in particular strains HN019 or Bl-04, which are commercially available from A/S.

The Bifidobacterium strain is inoculated into the milk in an amount of 10⁸ to 10¹¹ cfu/L, preferably from 10⁹ to 10¹¹ cfu/L.

The ratio between the Lactobacillus paracasei strain or the Lactobacillus rhamnosus strain and the Bifidobacterium strain inoculated into the milk is from 1:10 to 50:1, preferably from 1:1 to 20:1, more preferably from 5:1 to 15:1.

In still another particular embodiment, the invention concerns a method for preparing a food or feed product comprising:

inoculating a medium with a Bifidobacterium strain, a Lactobacillus acidophilus strain and a Lactobacillus strain selected from a Lactobacillus paracasei strain or a Lactobacillus rhamnosus strain.

The food or feed product is advantageously selected from the group consisting of beverages and a dairy product.

Beverages can be fruit juices, an ingredient to soft drinks, or a beverage comprising whey protein, health teas, cocoa drinks, milk drinks and lactic acid bacteria drinks, yoghurt and drinking yoghurt.

Advantageously, the dairy products can be fermented dairy products such as yogurt and cheese, yoghurt drinks, quark, kefir, fermented milk-based drinks, buttermilk, cheeses, dressings, low fat spreads, fresh cheese, soy-based drinks, ice cream, etc.

In a particular embodiment, the fermented diary is not a cheese-based dip.

Food products can also be ice creams, water ices and desserts, confectionery, biscuits cakes and cake mixes, snack foods, balanced foods and drinks, fruit fillings, care glaze, chocolate bakery filling, cheese cake flavoured filling, fruit flavoured cake filling, cake and doughnut icing, instant bakery filling creams, filing for cookies, ready-to-use bakery filling, reduced calorie filling, adult nutritional beverage, acidified soy/juice beverage, aseptic/retorted chocolate drink, bar mixes, beverage powders, calcium fortified soy/plain and chocolate milk, calcium fortified coffee beverage.

The medium to be inoculated can be the food or feed product itself or an ingredient or a mixture of ingredients of the food or feed product. The medium is advantageously selected from milk, fruit or vegetable juice, or any ingredients or food medium being part of the food products stated above.

In a preferred embodiment, the food or feed product is a fermented dairy product and the medium is milk. In this embodiment, the invention is thus directed to a method for preparing a fermented dairy product comprising:

inoculating milk with a probiotic strain, and a Lactobacillus strain, and a starter culture, and

fermenting the milk.

In the present invention, the term starter culture refers to a single or mixed culture comprising Lactobacillus delbrueckii ssp. and/or Steptococcus sp. and/or Lactococcus sp. or other lactic acid bacteria that ferment the dairy product.

In a first alternative of this embodiment, the invention is directed to a method for preparing a fermented dairy product comprising:

inoculating milk with a Lactobacillus acidophilus strain, a Lactobacillus strain selected from a Lactobacillus paracasei strain or a Lactobacillus rhamnosus strain, and a starter culture, and

fermenting the milk.

In a second alternative of this embodiment, the invention is directed to a method for preparing a fermented dairy product comprising:

inoculating milk with a Bifidobacterium strain, and a Lactobacillus strain selected from a Lactobacillus paracasei strain or a Lactobacillus rhamnosus strain, and a starter culture, and

fermenting the milk.

In third alternative of this embodiment, the invention is thus directed to a method for preparing a fermented dairy product comprising:

inoculating milk with a Bifidobacterium strain, a Lactobacillus acidophilus strain, and a Lactobacillus strain selected from a Lactobacillus paracasei strain or a Lactobacillus rhamnosus strain, and a starter culture, and

fermenting the milk.

The milk is fermented under suitable conditions known by the person skilled in the art to obtain the desired fermented dairy product. In a particular embodiment, the milk is fermented at 30 to 43° C. for a period of 5 to 10 h until reaching a pH of 4.7 to 4.2. The fermented dairy product such obtained is subsequently cooled and stored at this temperature until its consumption. The storage temperature is generally set at 4-6° C. but a break in of the cold chain can occur especially in areas wherein storage at cold, dry and constant temperature is difficult.

The fermented dairy product can be in a liquid or solid form such as yogurt, stirred yogurt, set yogurt, yogurt like drink, bitter milk, butter milk, sour cream, fresh cheese and cheese. Preferably, the fermented dairy product is selected from the group consisting of yogurt, stirred yogurt, set yogurt, and yogurt like drink. In particular embodiment, the fermented dairy product is yoghurt. In that case, it can further comprise other microorganisms commonly used in yogurt manufacture such as Streptococcus thermophilus and/or Lactobacillus bulgaricus, and present a pH of 4.2 to 4.6.

The milk can be either mammal milk, such as cow's milk, goat's milk or sheep's milk, or plant milk, such as soy milk.

The advantage of the method of the invention is that the presence of the Lactobacillus strain, such as L. paracasei strain and L. rhamnosus strain, increases the survival rate of probiotics, such as L. acidophilus strain, or strains from species that are related to Lactobacillus acidophilus, and Bifidobacterium ssp. strain. The survival rate of probiotic in the present invention represents the proportion of live bacteria of said probiotic remaining after a determined period of storage. Indeed, when considering for example fermented dairy products, the growth of probiotic bacteria, such as L. acidophilus and Bifidobacterium, gradually decreases after the fermentation step and the proportion of live probiotic bacteria in the fermented dairy product starts to decrease.

“Increasing the survival rate of a bacteria” as defined in present invention thus means retaining a concentration of live bacteria as close as possible to the concentration of the food or feed product just after manufacture (i.e. just after the fermentation step in case of fermented milk products), during a determined storage period at a determined temperature. The temperature can be 4-6° C. or higher. For example, it can be defined as retaining at least 2.5%, preferably at least 5%, more preferably at least 10%, even more preferably at least 30%, still even more preferably at least 50% of live bacteria of probiotic, relative to the concentration just after manufacture, after a period of storage of 30 days, preferably 80 days.

In a particular embodiment, the food or feed product contains at least three times, preferably 10 times, more preferably 20 times more viable Lactobacillus acidophilus, relative to the food or feed product without the Lactobacillus strain that enhances the survival rate of the probiotic strain, after 30 days of storage at 4-6° C. Alternatively, the food or feed product retains at least 2.5%, preferably 5%, more preferably at least 10%, even more preferably at least 50% of viable Lactobacillus acidophilus, relative to the concentration just after manufacture, after a period of storage of 30 days at 4-6° C. Alternatively, the food or feed product that contained 10⁹ cfu/L just after manufacturing contains at least 10⁹ cfu/L of viable L. acidophilus after 30 days of storage at 4-6° C.

In another particular embodiment, the food or feed product contains at least 30%, preferably at least 50%, more preferably 100% more viable Bifidobacterium, relative to the food or feed product without the Lactobacillus strain that enhances the survival rate of the probiotic strain, after 30 days, preferably 80 days, of storage at 4-6° C. Alternatively, the food or feed product retains at least 50%, preferably at least 75% more preferably at least 100% of viable Bifidobacterium, relative to the concentration just after manufacture, after a period of storage of 30 days, preferably 80 days, at 4-6° C. Advantageously, the concentration of Bifidobacterium in the food or feed product increases relative to the concentration just after manufacture. Alternatively, the food or feed product that contained 10⁹ cfu/L just after manufacturing contains at least 10⁹ cfu/L of viable Bifidobacterium after 30 days, preferably 80 days of storage at 4-6° C.

The recommended storage temperature for food or feed products containing probiotic is generally 4-6° C. However, a break in the cold chain can occur, especially in areas wherein storage at cold and constant temperature is difficult. Alternatively, the period of storage can suffer from a break in the cold chain so as the fermented dairy product is, for example, subjected to a temperature up to 30° C. for a total period up to 2 days. Indeed, the Lactobacillus strain, such as L. paracasei strain and L. rhamnosus strain, is particularly effective in protecting probiotics, such as L. acidophilus strain and Bifidobacterium ssp. Strain, when the fermented dairy product has been subjected to temperature abuse. This is particularly valuable for regions with harsh temperatures or where stability of probiotics is a problem, due to issues with temperature abuse or breaks in the cold chain during transportation.

The survival rate of probiotic is also affected by the pH of the food or feed product. Indeed, in the case of fermented dairy products, especially yogurt, the pH is generally from 4.6 to 4.2. The initial pH of such a fermented milk product (i.e. the pH of the product just after the fermentation step) is often kept around 4.5 to improve survival of probiotics. However, from a sensory point of view, a lower pH is often preferred. An initial pH of 4.2 is more detrimental for the survival rate of probiotic strains comprised into the fermented dairy product. Therefore, there is a need for a solution enhancing probiotic strain survival in this kind of fermented dairy products.

In a preferred embodiment wherein the food or feed product is a fermented dairy product, the fermented dairy product contains at least three times, preferably 10 times, more preferably 20 times more viable Lactobacillus acidophilus, relative to the fermented dairy product without the Lactobacillus strain that enhances the survival rate of the probiotic strain, after 30 days of storage at 4-6° C., wherein the fermented dairy product has an initial pH of 4.2. Alternatively, the fermented dairy product retains at least 2.5%, preferably 5%, more preferably at least 10%, even more preferably at least 50% of viable Lactobacillus acidophilus, relative to the concentration just after the fermentation step, after a period of storage of 30 days at 4-6° C., in a fermented dairy product with an initial pH of 4.2. In another preferred embodiment, the fermented dairy product contains at least 2.5 times and preferably 3 times more viable Lactobacillus acidophilus, relative to the fermented dairy product without the Lactobacillus strain that enhances the survival rate of the probiotic strain, after 80 days of storage at 4-6° C., wherein the fermented dairy product has an initial pH of 4.5. Alternatively, the fermented dairy product retains at lest 30%, preferably at least 40%, more preferably at least 50%, even more preferably at least 60% of viable Lactobacillus acidophilus, relative to the concentration just after the fermentation step, after a period of storage of 80 days at 4-6° C., in a fermented dairy product with an initial pH of 4.5.

Alternatively, the fermented dairy product, that contained 10⁹ cfu/L just after manufacturing, contains at least 10⁹ cfu/L of viable L. acidophilus after 30 days of storage at 4-6° C., in a fermented dairy product with initial pH of 4.2, or preferably at least 10⁹ cfu/L of viable L. acidophilus after 80 days of storage at 4-6° C., in a fermented dairy product with initial pH of 4.5.

In another preferred embodiment wherein the food or feed product is a fermented dairy product, the fermented dairy product contains at least 30%, preferably at least 50%, more preferably 100% more viable Bifidobacterium, relative to the fermented dairy product without the Lactobacillus strain that enhances the survival rate of the probiotic strain, after 30 days, preferably 80 days, of storage at 4-6° C., wherein the fermented dairy product has an initial pH of 4.2. Alternatively, the fermented dairy product retains at least 50%, preferably at least 75% more preferably at least 100% of viable Bifidobacterium, relative to the concentration just after the fermentation step, after a period of storage of 30 days, preferably 80 days, at 4-6° C., in a fermented dairy product with an initial pH of 4.2.

Alternatively, the fermented dairy product that contained 10⁹ cfu/L just after manufacturing, contains at least 10⁹ cfu/L of viable Bifidobacterium after 30 days, preferably 80 days of storage at 4-6° C., in a fermented dairy product with initial pH of 4.2.

The preceding percentages are expressed on the basis of the amount of Lactobacillus acidophilus and Bifidobacterium respectively just after the fermentation step.

The present invention also relates to the use of a Lactobacillus strain in the manufacture of a food or feed product containing a probiotic strain for increasing the survival rate of said probiotic strain during the storage of said product.

In one embodiment, the Lactobacillus strain that enhances the survival rate of the probiotic strain is for example selected from the group consisting of a Lactobacillus paracasei strain (or a Lactobacillus casei strain), or a Lactobacillus rhamnosus strain.

The probiotics are for example selected from the group consisting of Lactobacillus helveticus, Lactobacillus crispatus, Lactobacillus jensonii, Lactobacillus gasseri, Lactobacillus acidophilus and Bifidobacterium ssp.

Advantageously, the Lactobacillus strain that enhances the viability of the probiotic strain is a Lactobacillus paracasei strain or a Lactobacillus rhamnosus strain and the probiotic strain is a Lactobacillus acidophilus strain or a Bifidobacterium ssp. strain.

Preferably, the probiotic strain is a Lactobacillus acidophilus strain or a Bifidobacterium ssp strain.

Advantageously, the Lactobacillus paracasei strain is selected from the group consisting of the strains Lb2132, lbc-82, LC-10 and Lpc-37.

Advantageously, the Lactobacillus rhamnosus strain is selected from the group consisting of the strains Lr-32 and HN001.

Advantageously, the Lactobacillus acidophilus strain is selected from the group consisting of Lactobacillus acidophilus strains La-14 and NCFM.

The Bifidobacterium ssp. strain is advantageously selected from the group consisting of Bifidobacterium lactis, Bifidobacterium bifidium, Bifidobacterium longum, Bifidobacterium animalis, Bifidobacterium breve, Bifidobacterium infantis, Bifidobacterium catenulatum, Bifidobacterium pseudocatenulatum, Bifidobacterium adolescentis, and Bifidobacterium angulatum. Preferably, the bifidobacterium ssp. strain is a strain of Bifidobacterium animalis lactis, more preferably HN019 or Bl-04 strain.

The following examples illustrating the present invention represent specific embodiments of the invention and are not intended as limiting the scope of the invention.

### Examples 1-4

Milk base used for yoghurt fermentations was composed of 12% whole milk powder (Fonterra, NZ) reconstituted in distilled water. Ingredients were mixed and pasteurized at 90° C. for 10 minutes. Pasteurized milk cooled to 10° C. within minutes and subsequently stored over night at 4-6° C. before fermentation.

The milk was inoculated with Lactobacillus acidophilus (La-14) alone or in combination with a Lactobacillus paracasei strain (Lb2132, Lpc-37, Lbc-82 or LC-10) and fermented at 43° C. until pH 4.2 was reached. Thereafter, fermented milk was cooled to 10° C. within 30 minutes and stored at 4-6° C. for 30 days, unless specified otherwise. All fermentations were conducted with Streptococcus thermophilus and Lactobacillus delbrueckii bulgaricus (at 10⁹ cfu/L for Streptococcus thermophilus and at 10⁷ cfu/L for Lactobacillus delbrueckii bulgaricus). Inoculation rates (expressed in cfu/L) of Lactobacillus acidophilus and Lactobacillus paracasei are presented in table 1.

TABLE 1

| | Control | Ex. 1 | Ex. 2 | Ex. 3 | Ex. 4 |
|---|---|---|---|---|---|
| La-14 | 10⁹ | 10⁹ | 10⁹ | 10⁹ | 10⁹ |
| Lb2132 | — | 10¹⁰ | — | — | — |
| Lpc-37 | — | — | 10¹⁰ | — | — |
| Lbc-82 | — | — | — | 10¹⁰ | — |
| LC-10 | — | — | — | — | 10¹⁰ |

The survival rate of Lactobacillus acidophilus in yogurts was assessed on the day after fermentations and after storage of yoghurts for 10, 20 and 30 days. Survival rate of L. acidophilus was assessed by diluting aliquots of yoghurt (1 ml) in peptone water (1/10 dilutions). Dilutions were inoculated into MRS agar (pour plate) supplemented with clindamycin (10 μl/ml). Inoculated agar plates were incubated anaerobically for 48-72 hours at 37° C. The results are expressed as percent remaining viable cells of Lactobacillus acidophilus relative to viable cells of Lactobacillus acidophilus one day after fermentation (day 0). Results are presented in table 2.

TABLE 2

| Days | Remaining viable L. acidophilus | | | | |
|---|---|---|---|---|---|
| of | in yoghurt after storage (%) | | | | |
| storage | Control | Ex. 1 | Ex. 2 | Ex. 3 | Ex. 4 |
| Day 0 | 100 | 100 | 100 | 100 | 100 |
| 10 days | 13 | 69 | 42 | 22 | 39 |
| 20 days | 2.3 | 35 | 23 | 12 | 25 |
| 30 days | 0.7 | 3.9 | 17 | 2.5 | 7.7 |

In view of those results, L. paracasei is efficient for increasing the survival rate of L. acidophilus in yogurt with an initial pH of 4.2 which is not favourable for the viability of such a probiotic.

### Example 5-6

The yoghurts were prepared and stored in the same conditions as for examples 1-4 except the milk was inoculated with Lactobacillus acidophilus (La-14) alone or in combination with a Lactobacillus rhamnosus strain (HN001 or Lr-32). Inoculation rates (expressed in cfu/L) are presented in table 3.

TABLE 3

| | Control | Ex. 5 | Ex. 6 |
|---|---|---|---|
| La-14 | 10⁹ | 10⁹ | 10⁹ |
| HN001 | — | 10¹⁰ | — |
| Lr-32 | — | — | 10¹⁰ |

The survival rate of Lactobacillus acidophilus in yogurts was measured as mentioned in examples 1-4. The results show that the survival rate of L. acidophilus was efficiently increased with the presence of L. rhamnosus.

### Examples 7 and 8

The yoghurts were prepared and stored in the same conditions as for examples 1-4 except the milk was inoculated with Bifidobacterium animalis lactis (Bl-04) alone or in combination with a Lactobacillus paracasei (Lb2132, contained in Holdbac™ YM-C, or Lr-32). Inoculation rates (expressed in cfu/L) are presented in table 4.

TABLE 4

| | Control | Ex. 7 | Ex. 8 |
|---|---|---|---|
| B1-04 | 10⁹ | 10⁹ | 10⁹ |
| Holdbac YM-C | — | 10¹⁰ | — |
| Lr-32 | — | — | 10¹⁰ |

The survival rate of Bifidobacterium animalis lactis in yogurts was assessed on the day after fermentations and after storage of yoghurts for 30 days. Survival rate of Bifidobacterium animalis lactis was assessed by diluting aliquots of yoghurt (1 ml) in peptone water (1/10 dilutions). Dilutions were inoculated into TOS agar (pour plate) supplemented with lithium mupriocin (0.05 g/L). Inoculated agar plates were incubated anaerobically for 48-hours at 37° C. The results are expressed as percent remaining viable cells of Bifidobacterium relative to viable cells of Bifidobacterium one day after fermentation (day 0).

The results show that the survival rate of B. animalis lactis was efficiently increased with the presence of L. paracasei. Furthermore, the concentration of B. animalis lactis was retained and even increased as compared with the concentration of B. animalis lactis one day after the fermentation.

### Example 9

Milk base used for yoghurt fermentations was composed of 12% whole milk powder (Fonterra, NZ) reconstituted in distilled water. Ingredients were mixed and pasteurized at 90° C. for 10 minutes. Pasteurized milk cooled to 10° C. within 30 minutes and subsequently stored over night at 4-6° C. before fermentation.

The milk was inoculated with Lactobacillus acidophilus (La-14) alone or in combination with Propionibacterium freudenreichii subsp. Shermanii and/or Lactobacillus paracasei (Lb2132) and fermented at 43° C. until pH 4.5 was reached. Thereafter, fermented milk was cooled to 10° C. within 30 minutes and stored at 4-6° C. for 80 days. All fermentations were conducted with Steptococcus thermophilus and Lactobacillus delbruckii bulgaricus in the same conditions as above. Inoculation rates of Lactobacillus acidophilus, Propionibacterium freudenreichii subsp. Shermanii and Lactobacillus paracasei and the results are presented in table 5.

TABLE 5

| | | Comp. | Comp. | |
|---|---|---|---|---|
| | Control | Ex. 1 | Ex. 2 | Ex. 9 |
| La-14 | 10⁹ | 10⁹ | 10⁹ | 10⁹ |
| Lb2132 | — | 10¹⁰ | — | 10¹⁰ |
| P. freudenreichii | — | 10⁸ | 10⁸ | — |
| shermanii | | | | |

The survival rate of Lactobacillus acidophilus in yogurts was measured as mentioned in examples 1-4. The results are shown in table 6.

TABLE 6

| Days | Remaining viable L. acidophilus in | | | |
|---|---|---|---|---|
| of | yoghurt after storage (%) | | | |
| storage | Control | Comp. Ex.1 | Ex. 9 | Comp. Ex.2 |
| Day 0 | 100 | 100 | 100 | 100 |
| 30 | 72 | 57 | 67 | 31 |
| 60 | 24 | 52 | 62 | 36 |
| 80 | 18 | 49 | 60 | 11 |

These results confirm that Lactobacillus strain enhances the viability of Lactobacillus acidophilus in opposition to Propionibacterium freudenreichii subsp. Shermanii.

1. A Lactobacillus strain used in the manufacture of a food or feed product containing a probiotic strain for increasing a survival rate of said probiotic strain during storage of said food or feed product.

2. The Lactobacillus strain of claim 1, wherein the Lactobacillus strain is a Lactobacillus paracasei strain or a Lactobacillus rhamnosus strain and the probiotic strain is a Lactobacillus acidophilus strain or a Bifidobacterium ssp. strain.

3. The Lactobacillus strain of claim 2, wherein the Lactobacillus paracasei strain is selected from a group consisting of strains Lb2132, lbc-82, LC-10 and Lpc-37, wherein the Lpc-37 strain was deposited on the 3^{rd} of January, 2003, at the ATCC under the deposit number PTA-4798.

4. A method for preparing a food or feed product comprising:
inoculating a medium with a probiotic strain and a Lactobacillus strain that enhances a survival rate of the probiotic strain.

5. The method according to claim 4, wherein the probiotic strain is inoculated into milk in an amount of 10⁸ to 10¹¹ cfu/L.

6. The method according to claim 5, wherein the Lactobacillus strain that enhances the survival rate of the probiotic strain is inoculated into the milk in an amount of 10⁸ to 10¹¹ cfu/L.

7. The method according to claim 6, wherein the ratio between the Lactobacillus strain and the probiotic strain inoculated into the milk is from 1:10 to 50:1.

8. The method according to claim 6, wherein the Lactobacillus strain that enhances the survival rate of the probiotic strain is a Lactobacillus paracasei strain or a Lactobacillus rhamnosus strain.

9. The method according to claim 8, wherein the Lactobacillus paracasei strain is selected from a group consisting of strains Lb2132, lbc-82, LC-10 and Lpc-37, preferably Lpc 37.

10. The method according to claim 8, wherein the Lactobacillus rhamnosus strain is selected from a group consisting of strains Lr-32 and HN001.

11. A method according to claim 8, wherein the probiotic strain is a Lactobacillus acidophilus strain or a Bifidobacterium sp strain.

12. The method according to claim 11, wherein the Lactobacillus acidophilus strain is selected from a group consisting of strains La-14 and NCFM.

13. The method according to claim 11, wherein the Bifidobacterium strain is selected from a group consisting of strains HN019 and Bl-04.

14. The method according to claim 4, wherein the food or feed product retains at least 50% of viable probiotic relative to the concentration just after a fermentation step, after a period of storage of 30 days at 4-6° C.

15. The method according to claim 4, wherein the food or feed product is yogurt having an initial pH of 4.2 and a medium is milk.
